(19) United States
(12) Patent Application Publication
(10) Pub. No.: US 2003/0035925 A1
(43) Pub. Date: Feb. 20, 2003

(54) Protective covering for floor surface

(76) Inventor: Steven Dale Holt, Pearl River, LA (US)

Correspondence Address: THOMAS S. KEATY, KEATY PROFESSIONAL LAW CORP., 2140 WORLD TRADE CENTER, NO. 2 CANAL STREET, NEW ORLEANS, LA, 70130, US

(21) Appl. No.: 09/929,157

(22) Filed: Aug. 14, 2001

(51) Int. Cl. B32B 3/30

(52) U.S. Cl. 428/141

(57) ABSTRACT

A cover for hard-floor surfaces has transparency to allow visual appreciation of the pattern of the underlying hard-surface floor. The cover provides a cushion effect while minimizing an uneven surface structure of the hard-surface floor. The cover is easily placed and removed from the floor when not needed. The top surface of the floor has increased traction characteristics. The cover may be tinted or treated to provide ultraviolet ray protection to the hard-surface floor.

### BACKGROUND OF THE INVENTION

This invention relates to flooring materials, and more particularly to a covering to be placed over an existing solid floor to protect the floor surface as well as to increase the comfort of persons walking on the hard-surface floor.

Many private and public buildings contain floors made from solid materials, such as wood, brick, marble, and the like. Even though the hard-surface floor is longer lasting than carpet flooring, it still loses its surface shine and becomes scratched with prolonged use. Some of the surfaces, particularly those made of marble, require careful cleaning using materials without harsh abrasive and materials that would cause discoloration of the marble. Tile surfaces, such as ceramic tiles, also have use-related problems: grout between the tiles becomes more and more difficult to clean, scratches appear on the once shiny surface, hard objects may cause chipping of the tile, all of which gradually reduces the aesthetic appearance of the tile floor surface.

Additionally, the hard-surface flooring does not provide the same cushion effect as carpet flooring and is harsher on the feet of the user. When a person has to work in a building with hard-surface flooring and remain on his/her feet for eight or more hours during the day, a cumulative effect of the unyielding surface on the foot creates considerable discomfort.

Some of the surfaces, such as wooden floors and parquets, are easily scratched and deteriorate under the ultraviolet lights of the sun. The wood surfaces are widely used in homes and on exterior decks, where they are exposed to the environment and light damage, such as decks, porches and patios.

The present invention contemplates provision of a protective covering for hard-surface flooring that can be placed over an existing floor and removed at little expense to the building owner, or the user.

### SUMMARY OF THE INVENTION

It is, therefore, an object of the present invention to provide a protective floor covering that can be placed over an existing floor and removed, if desired, in an expeditious manner by the user.

It is another object of the present invention to provide a floor covering that will allow the user to see the hard floor surface underneath while protecting the surface against scratches and chipping.

It is a further object of the present invention to provide a protective floor covering having flexibility and resiliency to absorb the shock of walking on the hard-surface floor.

It is still a further object of the present invention to provide a floor covering that facilities protection of the underlying floor from ultraviolet ray damage, such as in decking, porches, and patios.

These and other objects of the present invention are achieved through a provision of a transparent floor cover to be removably placed on top of an existing hard-surface floor. The cover comprises a bottom layer that creates a cushion effect through its resilient soft characteristics and an upper layer attached or fused to the bottom surface. The bottom layer fills the crevices between elements of the hard-floor and makes the surface of the entire floor more even.

The cover may be tinted or treated to provide enhanced aesthetics, as well as, to provide protection to the floor against damage by ultraviolet rays. The top surface of the upper layer may have a plurality of tiny projections that increase traction of the cover. The cover may be made from transparent flexible plastic material that may be rolled for storage and unrolled for placing on the floor.

### BRIEF DESCRIPTION OF THE DRAWINGS

Reference will now be made to the drawings, wherein like parts are designated by like numerals and wherein,

FIG. 1 is a top view of the floor covering in accordance with the present invention.

FIG. 2 is a cross sectional view of the floor covering.

FIG. 3 is a top view showing the floor covering of the present invention placed over a wood floor.

FIG. 4 is a cross-sectional view showing the floor cover of the present invention placed over a wood floor.

FIG. 5 is a top view showing the floor covering of the present invention placed over a brick floor.

FIG. 6 is a cross-sectional view showing the floor cover of the present invention placed over a brick floor.

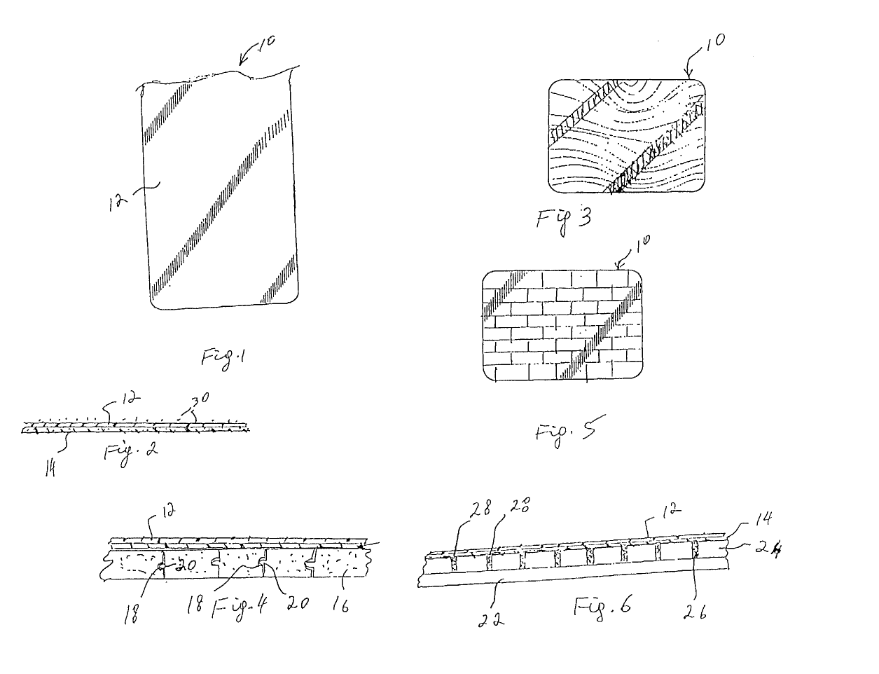

### DETAIL DESCRIPTION OF THE PREFERRED EMBODIMENT

Turning now to the drawings in more detail, numeral 10 designates the floor-covering panel in accordance with the present invention. The panel 10 can be supplied in a flat form to fit a particular size room or it may be sold in a rolled up form that the consumer unrolls and places on the floor where the protection is needed.

The panel 10 comprises an upper layer 12 and a bottom layer 14. The upper layer 12 has a shiny top surface, similar to high gloss linoleum. The upper layer 12 may be tinted or treated to provide protection against ultraviolet rays that are destructive to the underlying floor. The top layer may be made from polyvinyl chloride, polyamide or other similar plastic material.

To increase traction qualities of the cover 10, the top surface of the upper layer 12 may be provided with a plurality of tiny projections 30 that would reduce sleek surface of the plastic floor, while not substantially reducing the transparency characteristics of the cover 10.

The bottom layer 14 is made from a resilient, flexible, transparent material that provides a cushion effect to the panel 10. The bottom layer 14 does not interfere with the transparency of the covering 10 when placed over an existing hard-surface floor. The upper layer 12 and the bottom layer 14 are permanently attached, such as by fusing to form an integral cover structure.

The panel 10 is made from a flexible, resilient transparent material that allows seeing the pattern of the underlying floor. For instance, if the panel 10 is placed on a wood floor, the wood pattern of the underlying flooring can be seen, similar to the manner shown in FIGS. 3 and 4. As can be seen in the drawings, the bottom layer 14 is placed over wood planks 16 connected together with groove-and-tongue connectors 18 and 20.

If the panel 10 is placed on a brick floor, the underlying brick structure can be seen similar to the views shown in FIGS. 5 and 6. As can be seen in the drawings, the brick floor has a sub floor 22, on which rows of bricks 24 are positioned. The bricks are held together by mortar seams 26. The mortar seams 26 create small indentations 28 in the floor surface. These indentations are mostly filled in by the bottom layer 14 when the cover 10 is placed over the brick floor. As a result, the top surface of the upper layer 12 presents a more even surface for persons to walk on.

In operation, the user unrolls a roll of the material and cuts out the panel 10 to the desired size and shape to accommodate the expanse of the hard-surface floor in the room. The top layer 12 is easy to clean and it has no grooves, surface imperfections or surface irregularities conventionally associated with brick, cement, or tile floors. The bottom layer 14 being flexible and resilient, will fill the cracks and crevices of the hard-surface floor and make the top surface more even and easy to walk on.

The cover 10 having increased traction characteristics may be particularly useful in a gymnasium or in a children's room where safety concerns are particularly high. It is envisioned that in sport facilities, such as gymnasiums floors, the thickness of layers 12 and 14 may be greater than the thickness of these layers for panels used in a household environment, such as the kitchen, the vestibule, and other areas of the house.

The cushion effect of the bottom layer 14 will provide additional security for such environments as restaurants where fragile breakable items are often dropped. By providing the cushion effect to the fallen item, the panel 10 will help prevent breakage of the china pieces if they are accidentally dropped on the floor.

The same cushioning effect will help prevent injuries to persons who fall on the hard-surface floor. The panel 10 is also beneficial for retaining temperature of the enclosure in a more stable level. At different times, hard-surface floors, such as marble, become very cold in winter and require more energy to warm up. By placing the protective panel 10 over the cold floor, the homeowner can reduce the energy bill as the panel 10 reduces dissipation of heat.

Many changes and modifications can be made in the present invention without departing from the spirit thereof. I therefore pray that my rights to the present invention be limited only by the scope of the appended claims.

I claim:

1. A cover for a hard-surface floor, comprising a bottom transparent layer adapted to contact the floor and an upper transparent layer attached to the bottom layer.

2. The device of claim 1, wherein said bottom layer creates a cushion effect in the cover.

3. The device of claim 1, wherein said cover creates an ultraviolet ray protection for the floor.

4. The device of claim 1, wherein said upper layer has increased traction top surface.

5. The device of claim 1, wherein said upper layer is fused to said bottom layer to form a uniform transparent cover.

6. The device of claim 1, wherein said cover creates a flexible resilient covering for the hard-surface floor, while minimizing an uneven surface effect in the floor.

7. A cover for a hard-surface floor, comprising a bottom transparent layer adapted to contact the floor and an upper transparent layer attached to the bottom layer, said bottom layer creating a cushion effect in the cover, while minimizing an uneven surface effect in the floor.

8. The device of claim 7, wherein said cover creates an ultraviolet ray protection for the floor.

9. The device of claim 7, wherein said upper layer is provided with a plurality of tiny projections to increase traction of a top surface of the cover.

10. The device of claim 7, wherein said upper layer is fused to said bottom layer to form a uniform transparent cover.

11. A cover for a hard-surface floor, comprising a bottom transparent layer adapted to contact the floor and an upper transparent layer attached to the bottom layer, said bottom layer creating a cushion effect in the cover, while minimizing an uneven surface effect in the floor, said cover increasing traction of a floor surface.

12. The device of claim 11, wherein said upper layer is fused to said bottom layer to form a uniform transparent cover.

13. The device of claim 11, wherein said cover creates an ultraviolet ray protection for the floor.

14. The device of claim 11, wherein said bottom layer is formed from a soft flexible resilient material.
